(19) United States
(12) Patent Application Publication
(10) Pub. No.: US 2014/0351634 A1
(43) Pub. Date: Nov. 27, 2014

(54) Transparent Parity-Based Recovery System and Method for Storage Devices

(71) Applicant: Brahim Bakayoko, Chicago, IL (US)

(72) Inventor: Brahim Bakayoko, Chicago, IL (US)

(21) Appl. No.: 13/900,159

(22) Filed: May 22, 2013

(51) Int. Cl. G06F 11/10

(52) U.S. Cl. CPC G06F 11/10
USPC 714/15

(57) ABSTRACT

A transparent parity-based data recovery system and method is presented. Particularly, the system and method includes a data recovery management controller disposed in a communicative relation with a plurality of data storage devices and at least one parity storage device, wherein each of the plurality of data storage devices are independent of one another and wherein each include a complete and independent file system. The said data recovery management controller is transparent or otherwise unknown to the host system and configured to intercept or otherwise process read and/or write operations associated with a target data storage device. Parity data for said target data storage device is computed and stored.

### FIELD OF THE INVENTION

The present invention is generally directed to a data recovery system and method, and in particular, to a technique for implementing a parity-based recovery system that is transparent or otherwise not apparent or visible to the host system, allowing for implementation on virtually any operating system or machine, including but not limited to Windows based machines, and allowing for the use of completely independent, swappable hard drives or storage devices that do not share data or impact the data on other drives, or impact the implementation of the data recovery system and method of the present invention.

### BACKGROUND OF THE INVENTION

As more and more computer users, people and companies rely on the electronic storage of data for day-to-day operations, the need for data security in the event of a minimal or catastrophic data failure is needed. Accordingly, in order to meet the demand and/or need for data security and recovery, many people resort to disk arrays, oftentimes referred to as Redundant Array of Independent or Inexpensive Disks (RAID), which utilize redundancy to provide protection for data stored on the array.

Furthermore, while RAID implementations do generally provide redundancy or data security, they also distribute input and output workload across the multiple data drives associated with the single RAID array. For instance, the device driver or interface sends communications to the RAID system, which distributes the tasks among the various disk drives. In this regard, each of the disk drives associated with a common RAID array are in fact dependent on one another in that they necessarily do not include independent file systems or independent data. For instance, data corresponding to a single data file (e.g., a single image, photo, video, document, operating system files, etc.) is spread throughout the entire array and across multiple data disks, such that some pieces may reside on one drive and other pieces may reside on a different drive. For this reason, the drives associated with a common RAID array do not contain full and independent file systems, and therefore cannot be removed from the RAID array and be usable in another computer system without reformatting or destroying all of the data contained thereon.

Furthermore, it has often been a challenge for users of RAID arrays to add new data drives to an existing RAID array, without losing or having to reformat the entire array. Traditionally, in order to add a data drive to a RAID array, the entire RAID array must be backed up, reformatted, the new drive added, then the data recovered. The steps involved are tedious, time consuming, and most importantly, requires the reformatting of a data drive and loss of existing data.

There is thus a need in the art for a new system and method for providing parity or other recovery protection while being capable of maintaining truly independent disk drives such that the system and method is transparent to the host system allowing for greater flexibility, modification, and implementation. In particular, the proposed system and method would function in a manner that is unknown to the host system, meaning that that host system communicates with each independent disk drives as if they were each separate from one another and not disposed within an array. Accordingly, each of the drives would function independent of one another, be able to be removed, replaced, and added at will, and contain full and complete file systems, rather than being disposed in a common RAID array.

The proposed system and method would function to intercept or process the input/output or read/write operations between the host computer and the disk drives in order to compute recovery or parity data. The recovery or parity data would then be stored in one or more virtual or physical drives for use if any data is lost, corrupted, or failed. Such a system and method would provide the advantages of data security without the downfall of requiring combined disks in a single array.

### SUMMARY OF THE INVENTION

The present invention, as described herein, is generally directed to a system and method for implementing parity-based data recovery in a host computer system and/or implementing parity based RAID recovery schemes without the inherent downfalls associated with common or traditional RAID systems. Specifically, as will become apparent from the description herein, the system and method of the various embodiments of the present invention is structured and configured to be transparent to the host system in that the host system performs normal, standard or traditional read/write operations on attached or accessible data storage devices or hard disk drives, while the present invention performs the various tasks to implement a data recovery system and method unbeknownst to the host system.

Certain advantages of the transparency of the system and method of the present invention include, but are not limited to, that the system and method may be implemented on virtually any computer or operating system. Particularly, the system and method of the present invention will not impact or interrupt the generation and/or communication of certain input/output commands to and from the host system. This allows the present invention to be implemented without having to modify or reconfigure the operating system kernel or controller operating the IO commands with the data storage devices, as is common with implementing traditional RAID levels.

It should also be noted that, with the implementation of the system and/or method of the present invention, the data storage drives may remain independent of one another, unlike traditional RAID configurations. In particular, each drive or data storage device may be removed, replaced, or added at will without impacting the data stored on other drives, and without having to format, reformat or modify any of the drives involved. Accordingly, each of the various hard drives or data storage devices may, but need not necessarily, include different or independent file systems, e.g., NTFS, FAT32, etc.

Accordingly, the various embodiments of the present invention include a data recovery management controller, implemented via software, hardware or any combination thereof, which is structured and configured to intercept, receive, and/or otherwise process input/output or read/write commands associated with a target storage device. The data recovery management controller can be added to virtually any machine without having to modify the host system, the kernel or input/output controllers. Accordingly, as mentioned above, host system does not see a RAID implementation and instead sees independent hard drives or storage devices.

The data recovery management controller is configured to calculate parity or other recovery information or data and store the recovery data in a virtual or physical drive allocated for the same. When or if needed, the recovery data can be accessed to reconstruct failed, corrupt or lost data.

These and other objects, features and advantages of the present invention will become more apparent when the drawings as well as the detailed description are taken into consideration.

### BRIEF DESCRIPTION OF THE DRAWINGS

FIG. 1 is a schematic representation of the transparent parity-based recovery system as disclosed in accordance with at least one embodiment of the present invention.

FIG. 2 is a flow chart illustrating at least one embodiment of the method of the present invention and showing communication and interaction between the host system and the data recovery management system.

FIG. 3 is a high level flow chart illustrating the write forwarding of at least one embodiment of the transparent parity-based recovery method of the present invention.

FIG. 4 is a high level flow chart illustrating the read recovery of at least one embodiment of the transparent parity-based recovery method of the present invention.

Like reference numerals refer to like parts throughout the several views of the drawings provided herein.

### DETAILED DESCRIPTION OF THE INVENTION

As shown in the accompanying drawings, the present invention is generally directed to a system 10 and method 100 for implementing parity-based data recovery in a host computer system 20. In particular, and as will become apparent from the description provided herein, the system 10 and method 100 of the various embodiments of the present invention are implemented on or otherwise accessible by one or more host computer systems 20. The host computer system 20 is cooperatively structured and configured to perform various input and output control sequences, operations or commands on one or more attached or accessible data storage device(s) 25 (e.g., virtual or physical hard disk drives) as if the system 10 and method 100 were not present. Specifically, as will become apparent from the description herein, the system 10 and method 100 of the various embodiments is structured and configured to be transparent to the host system 20 in that the host system 20 performs normal, standard or traditional read/write operations on the attached or accessible data storage devices 25, while the present invention performs the various tasks to implement a data recovery system 10 and method 100 unbeknownst to the host system 20.

Certain advantages of the transparency of the system 10 and method 100 of the present invention include, but are not limited to, that the system 10 and method 100 may be implemented on virtually any computer or operating system, such as a WINDOWS system, LINUX system, APPLE OS system, etc. Particularly, the system 10 and method 100 of the present invention will not impact or interrupt the generation and/or communication of certain input/output (10) commands to and from the host system 20. This allows the present invention to be implemented without having to modify or reconfigure the operating system kernel or controller operating the IO commands with the data storage devices 25, as is common with implementing traditional RAID levels.

Other advantages, which will be described hereinafter, include the ability to remove, replace, or add one or more data storage devices 25 to and from the host system 20 and the system 10 and method 100 of the present invention without impacting the data stored on other data storage devices 25, and without having to format, reformat or modify any of the data storage devices 25 involved. Accordingly, for exemplary purposes only, a hard drive containing already stored data (e.g., removed from another machine) can be added to the system 10 and method 100 without having to reformat the drive and without losing the preexisting data stored thereon. Similarly, a hard drive or data storage device may be removed from the system 10 and method 100 of the present invention and connected to a different machine or system without having to reformat or lose the data stored thereon. Accordingly, it should also be noted that each of the various hard drives or data storage devices 25 may, but need not necessarily, include different and/or independent file systems (e.g., NTFS, FAT32, etc.) in that each of the data storage devices 25 of the various embodiments of the present invention are independent of one another, are not spliced or combined like traditional RAID formats, and can be independently accessed, written to, read from, removed, added, etc. without impacting the system 10 or method 100 of the present invention. Particularly, the data storage devices are not dependent on one another in that each comprises a complete and independent file system, meaning that a single file system is not shared or installed on multiple storage drives. Rather, a single storage drive contains a full, complete and independent file system.

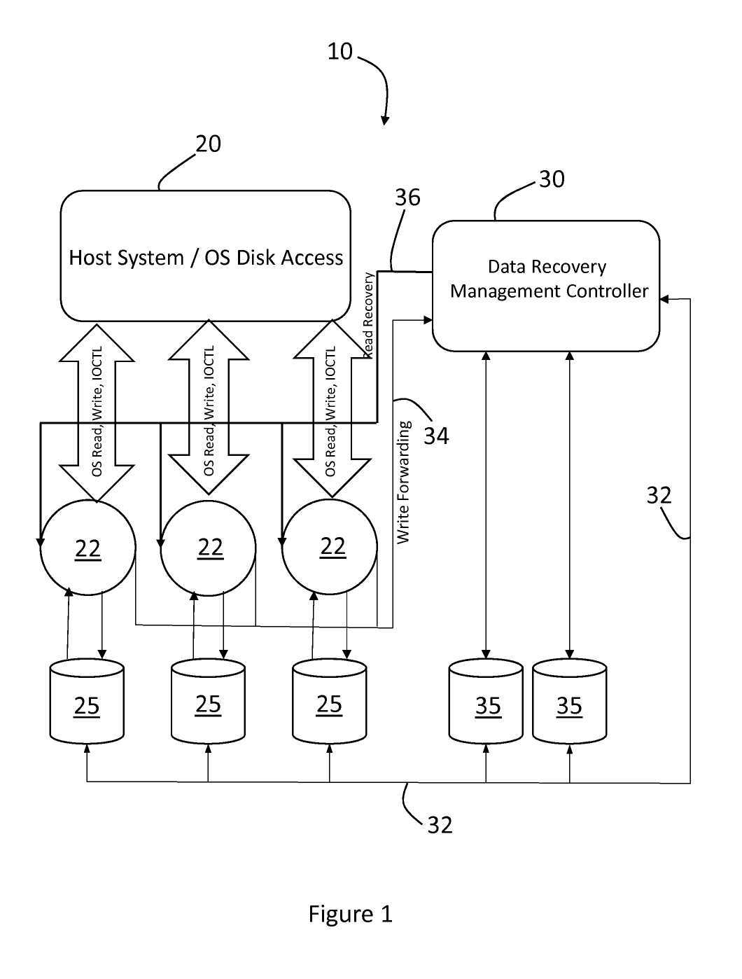

Referring now to FIG. 1, the system 10 of at least one embodiment comprises a data recovery management controller 30. In particular, it should be noted that the data recovery management controller 30 of the various embodiments of the present invention described herein may be hardware based, emulated through software and/or driver implementations, provided via a RAID or other type of controller device, or any combination thereof. In any event, the data recovery management controller 30 is structured and configured to implement the various features and functions of the present invention in the intended manner, as described herein and as shown in the Figures.

Particularly, still referring to FIG. 1, the data recovery management controller 30 of at least one embodiment is disposed in a communicative relation with the one or more data storage devices 25 and one or more parity or recovery storage devices 35. For exemplary purposes only, the data recovery management controller is communicatively disposed relative to the data storage devices 25 and/or the recovery storage devices 35 via one or more data buses, generally referenced as 32 in FIG. 1. This data bus 32 illustrated allows parallel read and write commands between the data recovery management controller 20 and the storage device(s) 25, 35. It should be noted that other schematics, data buses and communication protocols may be implemented.

Moreover, the various data storage devices 25, as described herein, may include any virtual or physical disk or device that can be used or is used to store and/or retrieve various data and/or media in online and/or offline modes. Accordingly, the data storage device 25 may include but is certainly not limited to an internal or external hard disk drive, solid state drive, USB drive, flash drive, virtual drive, network drive, etc. Similarly, the one or more recovery storage devices 35 may include any virtual or physical device or structure capable of storing and/or retrieving recovery data for subsequent use in the event of a data or disk failure. Particularly, the various recovery storage devices 35 may include, but is certainly not limited to, to an internal or external hard disk drive, solid state drive, USB drive, flash drive, virtual drive, network drive, etc. In certain embodiments, the recovery storage device(s) 35 may be separate, independent or dedicated drives or storage units, however, in other embodiments, the recovery storage device(s) 35 may include a shared, partitioned, or dedicated space on one or more of the data storage devices 25.

In any event, the various data storage devices 25 of the present invention are considered independent storage devices in that each one can be separately formatted and/or partitioned as desired without any impact or disruption to the other storage devices 25 of the system 10 and without any impact or disruption to the data stored on the other storage devices 25 of the system 10. Furthermore, each of the independent storage devices 10 of the present invention can host one or more unique volumes, each with a different (although not required) file system, and each volume being accessible via a separate interface the device 25 presents to the host system 20. Finally, an independent data storage device 25, as used herein, can be removed or added to the system 20, as desired, and its volumes readable and/or writable in another system outside of and different from the host system 20 and recovery system 10 of the present invention. It should also be noted that the data storage devices 25 may comprise a one-to-one mapping with the host system 20, meaning that the data does not overlap from one storage device 25 to another. In contrast, traditional RAID systems will map multiple hard drives to a single controller allowing the data contained in a single read or write operation to span across multiple drives.

Furthermore, the data recovery management controller 30 of at least one embodiment of the present invention is structured to intercept, obtain, or otherwise read and process certain input and/or output commands between the host system 20 and the data storage devices 25. Specifically, in certain embodiments, the data recovery management controller 30 can obtain or process the commands by pulling them from the host computer 20, driver, etc. In other embodiments, however, the device driver may be configured to push or forward the commands to the data recovery management controller 30 of the present invention for processing thereby.

In particular, the host system 20 is structured to send read/write (and other) commands to and from a target data storage device 25, either directly or via a device driver, controller, object, etc. The target data storage device being the storage device 25 the host computer 20 is communicating with, either directly or indirectly. Particularly, oftentimes, the host computer 20 communicates with or otherwise comprises one or more device drivers or objects 22 conceptually disposed between the host computer 20 and the data storage device 25 that controls, sends, and receives commands to and from the host computer 20 and the target data storage device 25. Specifically, and for exemplary purposes only, in a WINDOWS® based machine running on a MICROSOFT WINDOWS® operating system, the device driver(s) 22 may include or otherwise implement a Windows Physical Device Object (PDO) for a disk device.

As shown in FIG. 1, the data recovery management controller 30 of at least one embodiment, is disposed in a communicative relation with the device driver 22 via data bus 34 and structured to intercept or receive read and/or write commands to and from the device driver 22. Thus, when the host system 20 sends a read/write or other command such as an input/output control (IOCTL) command to the device driver 22 of a target data storage device 25, the data recovery management controller 30 of the present invention is structured to intercept, receive or otherwise process that command or communication via data bus 34 in order to implement certain embodiments of the present invention.

In certain embodiments, the host system 20 may communicate with a single device driver 22 that is common to all of the storage devices 25. In that case, each storage device 25 includes or is otherwise communicatively disposed with an abstracted representation within the device driver 22. It should be noted that each storage device 25, in at least one embodiment, may be communicative with separate and distinct device drivers 22.

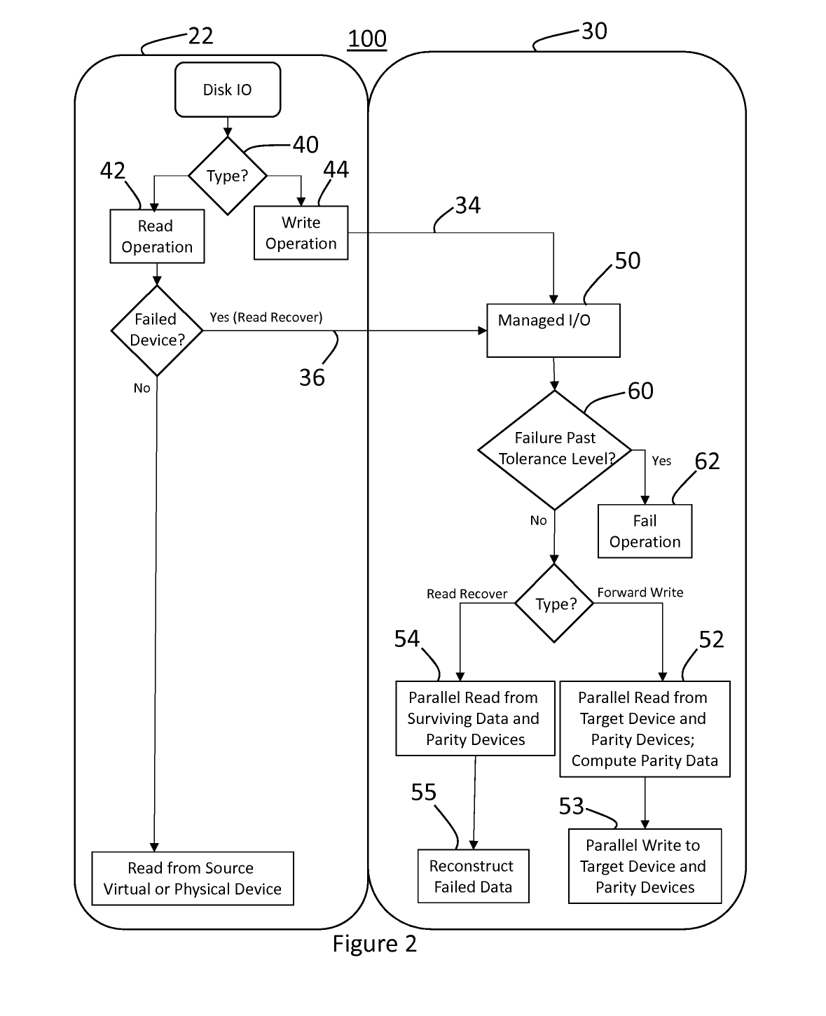

For example, FIG. 2 illustrates a high level conceptual flow chart of the method 100 of one embodiment, showing an exemplary interaction or communication between the device driver 22 and the data recovery management controller 30 of the present invention. In particular, as illustrated at 40, the driver 22 will determine whether the command is a read command 42 or a write command 44. If the command is a write command 44, that write command 44 is forwarded to or otherwise read, processed or intercepted (as generally shown at 50) by the data recovery management controller 30 via data bus 34.

In certain embodiments, the data recovery management controller 30 will determine whether the command is within a predetermined tolerance level, as shown at 60 in FIG. 2. If not, the command is determined to be a failed operation 62 and, in certain cases, aborted. Otherwise, the data recovery management controller 30 continues to process the command.

Still referring to FIG. 2 for a write command 44, as shown at 52, the data recovery management controller 30 is structured and configured to perform a read command on the target data storage device 25 and all recovery storage devices 35 associated with the target data storage device 25 (via data bus 32, shown in FIG. 1), and compute recovery data therefrom. As shown at reference character 53, the data recovery management system 30 is structured and configured to then conduct a write command to the target data storage device 25 and the recovery storage device 35, again via data bus 32. In particular, the write commands to the target data storage device 25 and the recovery data storage device 35 may be completed in parallel on the same, common or shared data bus 32. The write command to the data storage device 235 will include a write to store for the initial data contained in the initial write command generated by the host system 20. The write command to the recovery storage device 35 will include the calculated recovery data.

In particular, the recovery data, as used herein, may include parity data or other type of data that is configured to be used in a manner to assist with the recovery of lost or failed data, for example, due to a failed or corrupt data drive. In general, and for exemplary purposes only, parity data can include, but is not necessarily limited to, an XOR computation of all of the data blocks. The parity data of at least one embodiment is then stored in a parity or recovery drive 35. When the target drive 25 fails or becomes corrupted, the parity data can be used in combination with data that did not fail or become corrupt in an attempt to recover or reconstruct the failed data.

Furthermore, if the intercepted or forwarded command from the device driver 22 to the data recovery management controller 35 includes a read recovery command 42, such as in the case where the host system 20 attempted to read from a corrupt or failed data storage device 25, the data recovery management controller 20 is configured to determine whether the read command or read recovery command is within a certain tolerance level that can still recover or reconstruct at least some of the failed, lost or corrupt data. If so, as referenced at 54, the data recovery management controller 20 is configured to read the surviving data, or otherwise the data that is capable of being read or interpreted (if any) from the target data storage device(s) 25. The data recovery management controller 25 will further conduct a read command or otherwise obtain the recovery or parity data previously computed and stored. As shown at block 55 of FIG. 2, using the data stored and read or obtained from the data storage device(s) 25 and the recovery storage device(s) 35, the data recovery management controller 30 is structured to reconstruct the failed, lost or corrupt data.

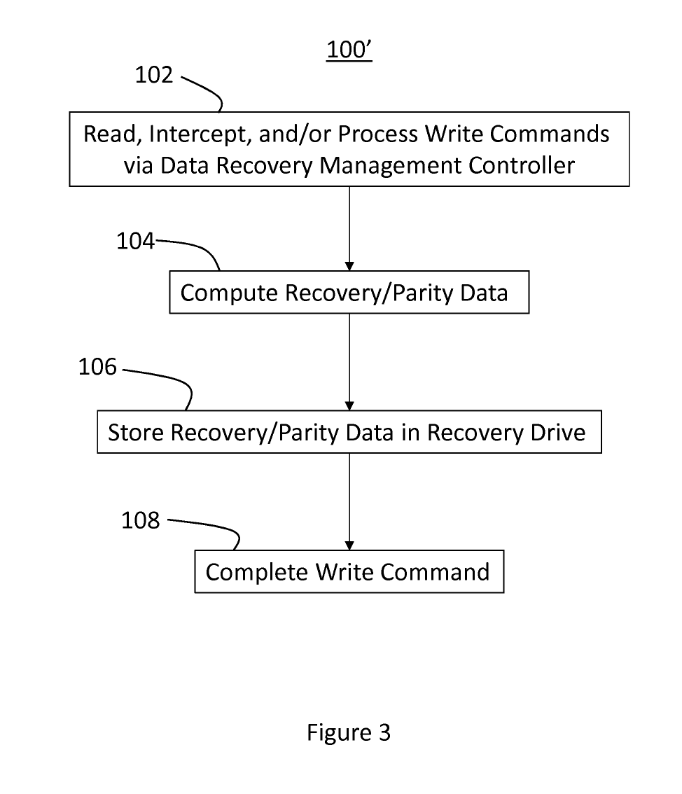

Referring now to FIG. 3, a method 100′ illustrating the write forwarding or processing of at least one embodiment of the present invention comprises processing a data write command via a data recovery management controller, generally illustrated at reference character 102. In particular, as mentioned herein, the data recovery management controller 30 may be disposed in a communicative relation with a host computer or system 20, data storage device 25 and/or device driver 22 in order to intercept, receive, read or otherwise process certain read and write commands to and from a target data storage device 25.

In certain embodiments, the data recovery management controller 30 is transparent to the host system 20 in that the host system 20 operates without regard to the data recovery management controller 30. Specifically, the host system 20 is structured to perform standard or traditional read and write operations to the data storage device(s) 25, for example, via device driver(s) 22. In this manner, the kernel or operative system of the host system 20 need not be modified or specifically configured to conform to the system 10 or method 100 of the present invention. This allows the system and method 100 of the various embodiments disclosed herein to be installed, retrofitted, or implemented on virtually any already running, operating and configured host system 20.

Furthermore, the data storage devices are defined as being independent and capable of being removed from the host system without impacting data stored on the data storage device itself or any remaining data storage devices 25 still connected to communicable with the host system 20. In particular, the data storages devices of at least one embodiment each comprise separate and independent file systems and full data schemes, meaning that the data written to each data storage device is complete and not shared amongst other data storage devices. Particularly, in a traditional RAID configuration, multiple drives are mapped together as one drive such that the host system will write data to the drives and the data will span across or be shared by multiple drives. This does not allow the drives to be separated from one another without losing data, reformatting, etc., and consequently, the drives in traditional RAID implementations are not independent.

Still referring to FIG. 3, the method 100′ of at least one embodiment further comprises computing parity or other recovery data corresponding to the target data storage device and the data associated with the write command, generally illustrated as reference character 104. In particular, the method 100′ of one embodiment will include a parallel read or operation from the target data storage device 25 and all parity or recovery devices 35 in order to compute recovery data. It should be noted that that read operations performed on the target storage device 25 recovery devices 35 need not necessarily be conducted in parallel and may thus be sequential or performed in serial to one another. For example, the recovery data may include, but is not limited to, parity data which may be computed by conducting an XOR command on the data. Other computations now known or later developed may be implemented.

Once computed, the parity or other recovery data is then stored in the parity or recovery data storage device(s) 35, as generally illustrated as reference character 106. In certain embodiments, the parity or recovery data is calculated and/or stored independently for each of the plurality of data storage devices 25. In other words, the parity data can be grouped or saved in a manner such that it is recoverable for each data storage device independently. For example, if one data storage device 25 fails, the parity data for the failed drive can be easily located or retrieved for data recovery.

Particularly, the recovery data can be used at a later time, if necessary, in order to recover or reconstruct failed or lost data, for example, in the event of a failed or corrupt drive. For instance, surviving data (e.g., data that is not corrupt, lost, or failed) can be read by the method 100′ and compared or computed with the parity or other recovery data to reconstruct, regenerate, or recover the failed or lost data. As shown at 108, the original write command may then be completed on the target device, for example, by saving the data to the target data storage device 25.

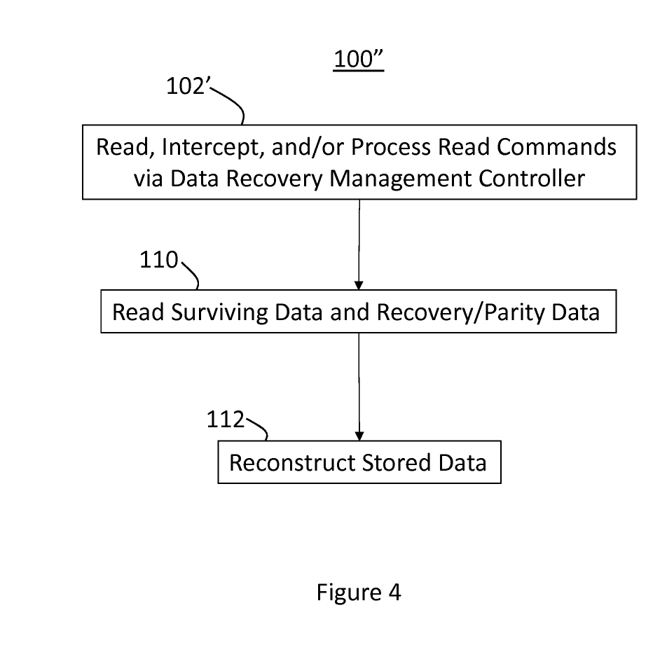

Referring now to FIG. 4, a method 100″ illustrating the read recovery of at least one embodiment is presented. In particular, as shown at 102′, the data recovery management controller is structured to process one or more read commands associated with a target data storage device. Moreover, the read recovery operation is conducted in a manner to recover failed data from the target data storage device. Accordingly, as shown at 110, the method 100″ comprises reading the surviving data and the recovery/parity data. Particularly, the surviving data, as used herein, includes the data that has not failed or is otherwise still within a failure tolerance level. In this manner, the surviving data can be computed with the parity data read from the parity drives to reconstruct the data, as generally represented at 112. The computation may take on any number of forms and use any of a variety of formula, equations, XOR commands, etc. in order to recover or reconstruct the failed or lost data.

This written description provides an illustrative explanation and/or account of the present invention. It may be possible to deliver equivalent benefits and insights using variations of the sequence, steps, specific embodiments and methods, without departing from the inventive concept. This description and these drawings, therefore, are to be regarded as illustrative and not restrictive.

Now that the invention has been described,

What is claimed is:

1. A parity-based data recovery system for a host computer, comprising:
a data recovery management controller disposed in a communicative relation with a plurality of data storage devices and at least one parity storage device, each of said plurality of data storage devices being independent of one another and each comprising a complete file system,
said data recovery management controller being configured to process write operations associated with a target one of said plurality of data storage devices, and compute parity data for said target data storage device, wherein said data recovery management controller is transparent to the host system, and
wherein said data recovery management controller is configured to store said parity data in said at least one parity storage device for subsequent data recovery corresponding to said target data storage device.

2. The system as recited in claim 1 wherein said parity data is calculated and stored independently for each one of said plurality of data storage device.

3. The system as recited in claim 1 wherein each of said plurality of data storage devices comprises one-to-one mapping with the host system.

4. The system as recited in claim 3 wherein each of said plurality of data storage device is disposed in a communicative relation with a separate abstracted representation of at least one I/O driver.

5. The system as recited in claim 1 wherein each of said plurality of data storage devices are capable of being removed from said parity-based data recovery system without impacting data stored on remaining ones of said plurality of data storage devices.

6. The system as recited in claim 1 wherein said data recovery management controller is configured to allow at least one additional data storage device to be added without impacting data stored on said plurality of data storage devices.

7. The system as recited in claim 1 wherein each of said plurality of data storage devices comprise an independent file system configuration.

8. The system as recited in claim 1 wherein said data recovery management controller is configured to intercept the write operations.

9. A data recovery method for storing recovery information and reconstructing failed data from a storage device of a host computer, the method comprising:
processing, via a data recovery management controller, data write commands for writing data to a target data storage device, the data recovery management controller being disposed in communicative relation with at least one storage device driver and the target data storage device, the data recovery management controller being transparent to the host system,
computing recovery information corresponding to the target data storage device and the write command,
storing the recovery information in a recovery data storage device, and
completing the write command to the target data storage device.

10. The method as recited in claim 9 further comprising defining the host system as comprising a plurality of independent data storage devices wherein the host system is structured to generate read and write commands for each of the plurality of independent data storage devices.

11. The method as recited in claim 10 wherein each of the independent data storage devices comprises an independent data file system wherein each of the independent data storage devices is capable of being removed from the host system without impacting data stored on remaining ones of the plurality of independent data storage devices.

12. The method as recited in claim 9 wherein completing the write command to the target data storage device is accomplished by the data recovery management controller.

13. The method as recited in claim 12 wherein storing the recovery information and completing the write command is accomplished via a parallel write to the target data storage device and the recovery data storage device.

14. The method as recited in claim 9 further comprising defining the recovery information as comprising parity data.

15. A data recovery method for storing parity data and reconstructing failed data from at least one of a plurality of independent storage devices of a host computer, the method comprising:
intercepting, via a data recovery management controller, a data write command for writing data to a target data storage device, the data recovery management controller being disposed in communicative relation with the target data storage device and a storage device driver associated with the target data storage device,
defining the data recovery management controller as being transparent to the host system wherein the host system operates without regard to the data recovery management controller,
defining each of the plurality of independent data storage devices as comprising an independent data file system, wherein each of the independent data storage devices is capable of being removed from the host system without impacting data stored on remaining ones of the plurality of independent data storage devices,
computing parity data corresponding to the target data storage device and the data associated with the write command,
storing the parity in a parity data storage device, and
completing the write command to the target data storage device.

16. The method as recited in claim 15 wherein the parity data is grouped within the parity data storage device based upon a corresponding one of the plurality of independent data storage devices.

17. The method as recited in claim 15 further comprising reading any surviving data from data failure of a failed data storage device, and using the parity data stored in the parity data storage device corresponding to the failed data storage device, reconstructing failed data therefrom.
